(19) United States
(12) Patent Application Publication
(10) Pub. No.: US 2020/0317038 A1
(43) Pub. Date: Oct. 8, 2020

(54) Hail Stopper III

(71) Applicants: Gregory Lee Hobson, Topeka, KS (US); Mitchell Gregory Hobson, Topeca, KS (US)

(72) Inventors: Gregory Lee Hobson, Topeka, KS (US); Mitchell Gregory Hobson, Topeca, KS (US)

(21) Appl. No.: 16/873,489

(22) Filed: Apr. 21, 2020

Related U.S. Application Data
(60) Provisional application No. 62/922,723, filed on Aug. 26, 2019.

(51) Int. Cl. B60J 11/04

(52) U.S. Cl. CPC B60J 11/04

(57) ABSTRACT

The Hail Stopper III is made with plastic and rubber or both, stop hail from damaging vehicles, comes in small, medium, and large sizes range from zero to ¼ inch, add another large let's say ¼ inch thick, this will super strength and use six inch thick size Hail Stopper III, there two combinations one goes up to six inches and can stop baseball size hail also the extra super stretching plastic cover added extra, with extra cost, this will help the air protection system give maximum protection for baseball size hail

### CROSS REFERENCE TO RELATED APPLICATION

Hail Stopper application/control/Number; 1B/136 art unit 3612, provisional patent application No. 62/606,277 Hail Stopper II, also claiming Micro Entity

### BACKGROUND OF INVENTION

Man has been using various types of protection for vehicles, from car covers to sheds, tents, garages, and car ports, though these devices are effective everyone does not have the room or cannot afford a car port or a garage, that is why they do not compare to what we have designed, also this product is portable and can be carried around with you in case you are out taking care of business, this product can save you thousands of dollars of damage that we cannot afford, the Hail Stopper III is placed over a vehicle when damaging weathers is forecasted such as hail storms, powerful thunder storms with winds carrying debris such as small branches and trash that would damage a vehicle and could save your life.

### BRIEF SUMMARY OF INVENTION

Hail Stopper III is made to protect vehicles from hail damage for small, medium, and large vehicles, but this product can be made to cover any size vehicle, custom made will cost extra for recreation vehicles, buses, trucks, tractor trailers, motorcycles, riding lawn mowers and more boats, planes this product is amazing, this product can save thousands of dollars of repairs from hail damage, also portable and because it is inflatable, it reduces down in size, taking less amount of space and can be stored in the trunk of a vehicle, this product should not be used while vehicle is in operation or moving it will work its way off the vehicle and cause more damage to your vehicle or to other drivers, the reason why I can't insure, it is inflatable and can be over filled and bust, someone could cut it, run into it, hit it with a bike, shopping cart, car or something can fall out of the sky such as than hail like meter showers, air plane parts, who knows, tornados and high winds throwing debris, this product really works to protect vehicles or property from hail damage so let's talk about how it is made and work, there is a Hail Stopper III material air protection system, this system is created with in the Hail Stopper III as it is being made from all practical purpose we will use a medium size vehicle to demonstrate the design and specification for this application, first a plastic sheet seven foot wide by twenty five foot long, to cover the whole top of the vehicle from bumper to bumper, cover the bumper, hood, roof, trunk and back bumper not the sides, then take a sheet of rubber that can expand and stretch, like material that an inner tube is made of for a bike, the size of the rubber sheet is twenty four by six inches long and glue it in a special way start three inches in with no glue for the tie down system after the two holes at the ends, that go six inches of glue all the way around the seven foot wide by twenty five foot long plastic cover that will become the shell, then another three inches with no glue space down both sides of the plastic twenty five foot long sides, this will become an air filling channel system this will allow you to inflate the Hail Stopper III creating an air flow system, on both sides of the plastic sheet going to all twelve inches thick spaces with no glue this will allow the Hail Stopper III air protection system to be inflated with an air nasal going through the plastic cover into the created air channels, with air applied with inflate the rubber creating the Hail Stopper III air protection system giving the Hail Stopper III air protection system the ability to protect the vehicle, this air protection system will be applied to all sides of the vehicles top, and sides to encapsulate the whole vehicle with the Hail Stopper III material air protection system, the three inches that is not glues create an air passage channel on both sides that allows air flow to the unglued twelve inch spaces to inflate the Hail Stopper III like a bike inner tube, after that you go from the top width of the plastic sheet you already have the six inch thick glue at the top edge then go twelve inches down with no glue, four more inches thick glue than another twelve inches of space than four more inches of glue, then repeat this process until you reach the bottom of the plastic sheet, seven foot by twenty five foot long sheet, note remember not to cover three inches air channel after the six inch glue down on both longitudinal position sides of the twenty five foot plastic cover this becomes the air filling channel where air will flow to fill the Hail Stopper III material air protection system, air hitting the twelve inches thick spaces with no glue filling them up, expanding and this system will air up like a bike inner tube and can be adjusted to get thicker as the hail gets larger for better protection, this system is adjustable for small, medium and large hail giving the Hail Stopper III the ability to stop hail damage I call it the Hail Stopper III material air protection system, and if you need more protection because you're getting baseball size hail you should get extra plastic ¼ inch sheet to put over the first ¼ inch sheet to super strength the Hail Stopper III extra cost is expected for another sheet of seven foot wide by twenty five foot long plastic sheet, this one inflated four inches high we make another one that inflates six inches high the super Hail Stopper III will stop baseball size hail, the sides of the Hail Stopper III are basically made as the top part of the Hail Stopper III with one exception the driver side is made so you can get inside the vehicle will cost a little more than the complete three side Hail Stopper III also if you want the passenger side to open another increase will be applied, so they are made like this two pieces ten foot longitudinal position by ten foot wide plastic cover with one quarter inch plastic cover, apply glue six inches wide around the plastic ten foot by ten foot wide, there are three inches unglued for air channel to fill, down the ten foot side this will allow the ten foot long by ten foot wide air panel to be inflated, two straps made of nylon will go inside the window and two straps in the door, to close you in the vehicle another and one or two on the bottom, to support the other door to keep the Hail Stopper III secure to the vehicle, if it is a four door vehicle four straps on the top four on the side two on one side of the panel and two on the other panel and one for the driver's side and once for the back passenger side of a four door vehicle, there is a hook and loop fastener material on the bumper to the one in the middle of the hood, one on the middle of the glass, one on the roof, one on the back window, located in the middle of the window, and one on the trunk, one on the back bumper to connect the top to the sides of the Hail Stopper III please note could be less for the solid Hail Stopper III and more for the half to gain entrance or more to gain entrance for the passenger side that why the cost differs also a tie down assembly will keep the Hail Stopper III attached to the vehicle in a bad windstorm, size of hail in your area if it is a quarter inch not much air is needed but it has to be inflated to protect your vehicle, also a twelve volt battery powered air pump, hook and loop fastener material and attachment straps, please note the right side elevation is made in the mirror image of the left side unless you want the driver entrance or both entrances of the passenger side, price will vary, to add more air if hail is larger, a six inch higher super-size Hail Stopper III is made to stop baseball size hail buy the one that is need and fits the hail size in your area, also no more scraping ice, or snow, no more frozen key lock on the doors, not more chemicals to deice doors, locks, windows, 100% green,

### BRIEF DESCRIPTION OF SEVERAL VIEWS OF THE DRAWING

FIG. 1 shows elongated view of the Hail Stopper III, zero to IA inch plastic or rubber covering seven foot by twenty five foot with four holes to tie down the assembly and twelve places of hook and loop fastener material applied, seven foot by twenty five foot plastic top covering

FIG. 2 shows elongated view of the rubber bottom after one inch holes, four places would be approximately twenty four foot by six inches, some with holes and some without.

FIG. 3 shows the glue pattern for all panel

FIG. 4 shows the completed assembly top of the Hail Stopper III

FIG. 5 shows how the one side is made and kept securely to the vehicle using hook and loop fastener material, rubber rope, all panels will have an inflation valve and a deflating plug

FIG. 6 shows circle with holes attach rubber ropes to keep assembly secure to the vehicle

FIG. 7 shows rubber rope six needed, different lengths to hold assembly to the vehicle

FIG. 8 shows air pump, twelve volt electric powered, as needed

FIG. 9 shows deflating air plug and hole

FIG. 10 shows inflating valve

FIG. 11 shows glue

FIG. 12 hook and loop fastener material needed

### DETAILED DESCRIPTION OF THE INVENTION

FIG. 1, with respect to the drawing, I will be demonstrating the medium size Hail Stopper III, shows an elongated side view of the top of the Hail Stopper III, twenty five foot long could be plastic, or rubber or both plastic top, and rubber bottom inflatable panels could inflate four inches for the twelve inch space or six inches with the eighteen inch spaces cavities created with in the glue to give Hail Stopper III its ability to protect the vehicle, this product cannot be limited, it could cover recreational vehicles, buses, trucks, tractor trailers, motorcycles, riding lawn mowers, and even cover roof tops, boats, planes, and more, whatever you want to protect from outside elements from acid rain, rust, ice storms, debris getting inside, and of course hail storms, this product is amazing could be made in any size and can save thousands of dollars in repair costs from outside elements and hail damages, also portable and because it is inflatable, it reduces down and takes up small amount of space, can be stored in the trunk of a vehicle, this product should not be used while vehicle is in operation or moving, very dangerous it will work its way off the vehicle and cause an accident dangerous to your vehicle and to other drivers, the reason why I can't insure. It is inflatable and could be poked, stabbed, or busted, can be over filled, and buss, does not protect if large tree limbs, meteor showers, anything can fall out of the sky, tornadoes, or very high winds throwing debris around, who knows, this product really works to protect your vehicles or property from hail damage,

FIG. 1 is a plastic and rubber material zero to ¼ inches thick and could be thickened, twenty five foot by seven foot with hook and loop fastener material in twelve places, a inflating valve and a deflating plug and four holes about two inches from the corners to tie down the assembly to the vehicle,

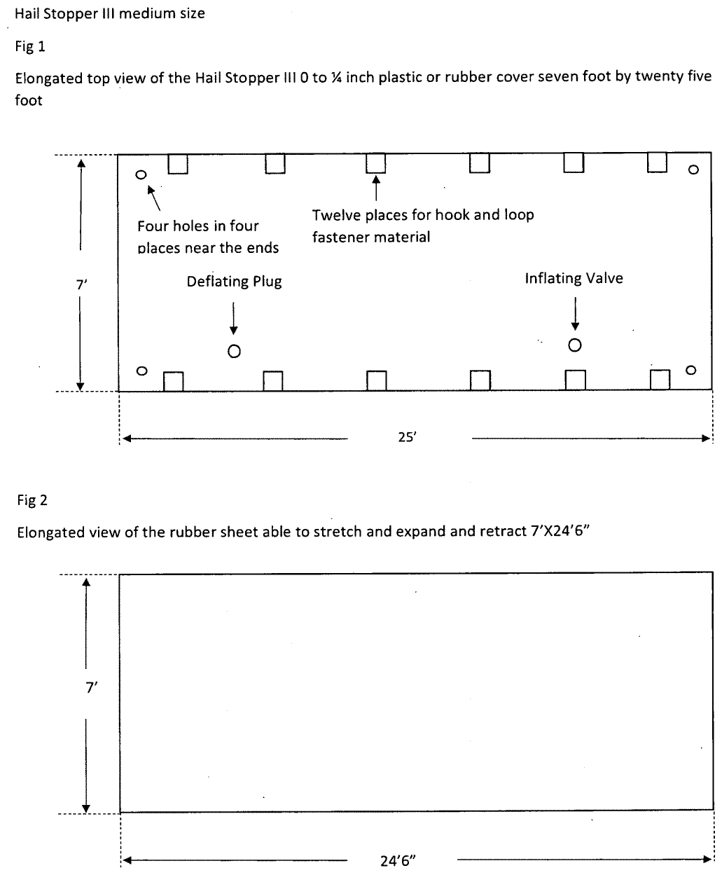

FIG. 2 elongated view of the plastic or rubber sheet able to stretch, expand and retract, 6′6″ by 24′6″ cut to fit after the four tie down holes,

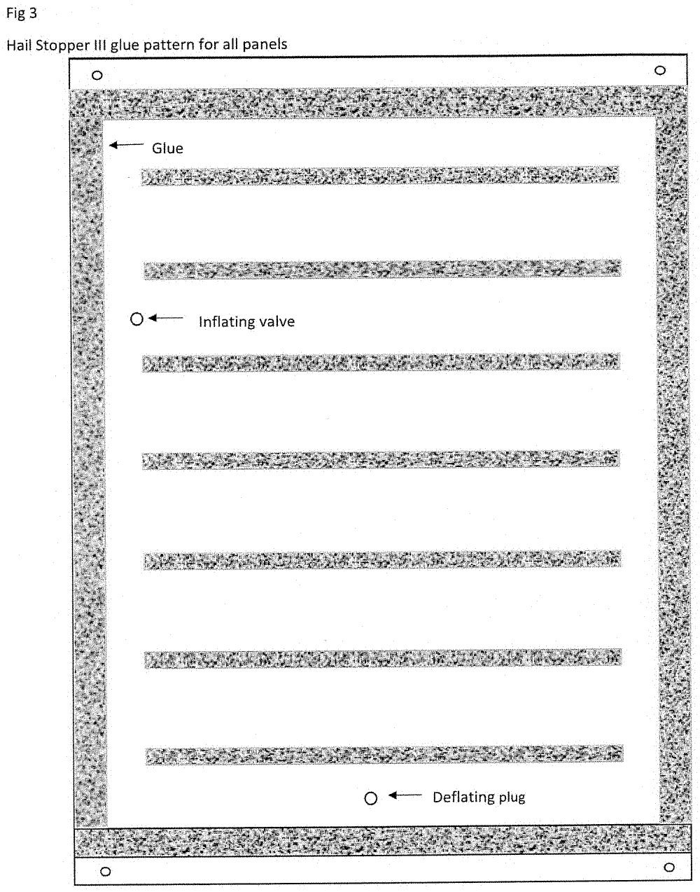

FIG. 3 is the glue pattern for all panels start with the plastic or rubber twenty five inch by seven inch after the holes apply glue about four inches thick all around the twenty five inch by seven inch plastic or rubber sheet go three inches away from the four inch applied glue, this will create an air channel on both sides of the FIG. 3 that the Hail Stopper III can be inflated, then go twelve inches then four inches of glue complete this process all the way to the end, there's an inflated valve and a deflated plug, place FIG. 2 of top of FIG. 1,

FIG. 4 completed view FIG. 1 and FIG. 2 makes FIG. 3 shows twenty five inch plastic cover or rubber FIG. 1 glued to FIG. 2 rubber sheet seven foot by twenty foot long with glue FIG. 3 to create FIG. 4, this shows an inflated top of Hail Stopper III with inflating valve, deflating plug inflated

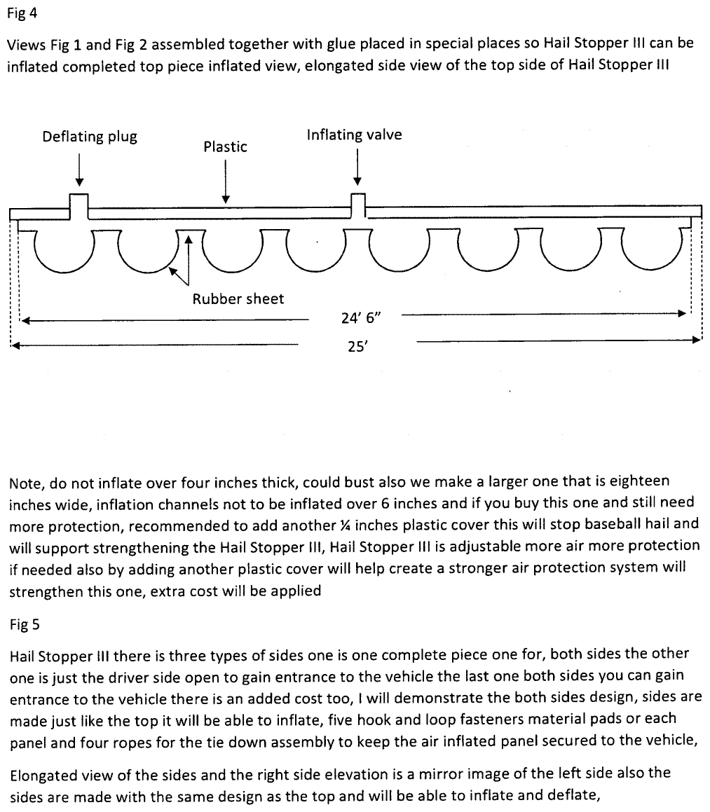

FIG. 5 shows the two completed air panels ten foot by ten foot with inflating valve and deflating plug total eight pieced of hook and loop fastener material four circles with holes and three rubber ropes to hold down assembly against vehicle, please note the first side view is the opposite mirror image of the second view and the right side elevation view is a mirror image of the left side,

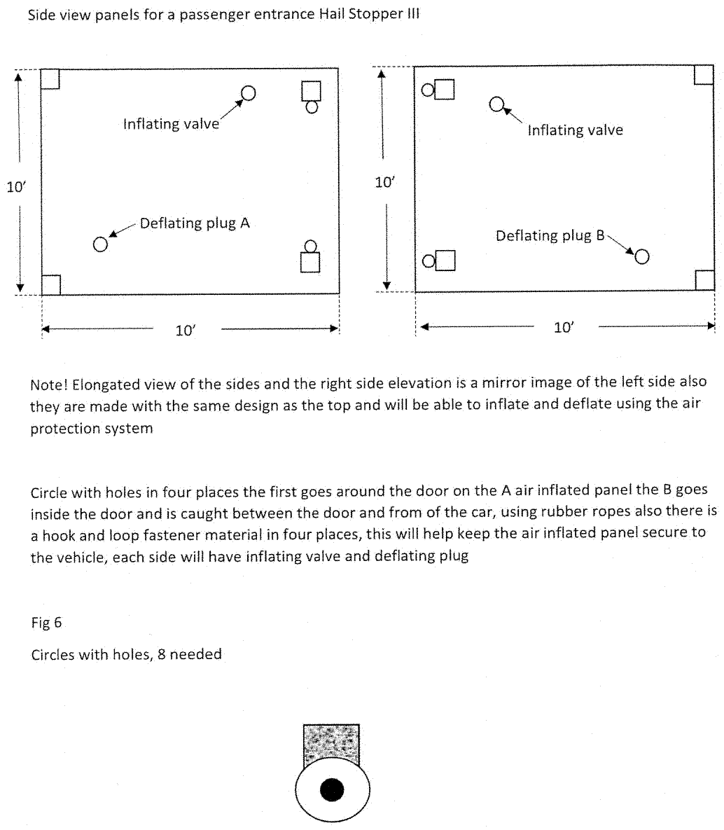

FIG. 6 shows tape with glue material attached to a plastic or rubber circle, eight needed

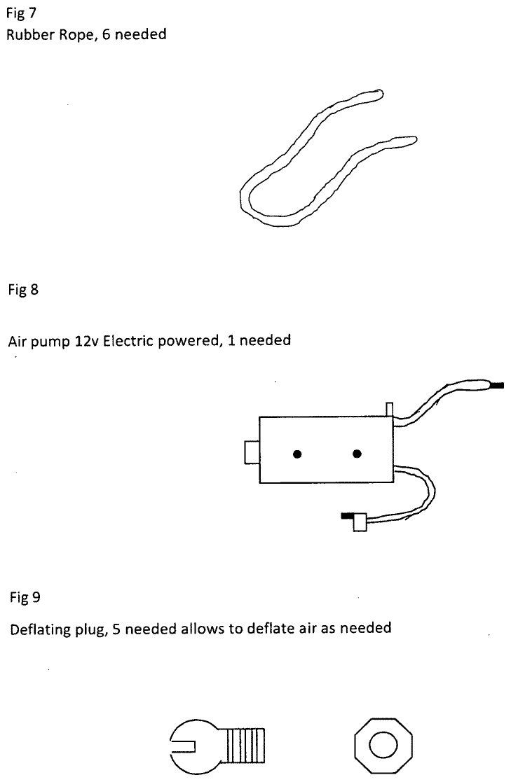

FIG. 7 shows rubber rope, six needed

FIG. 8 shows twelve volt electric powered air pump, one is required

FIG. 9 shows deflating plug and hole

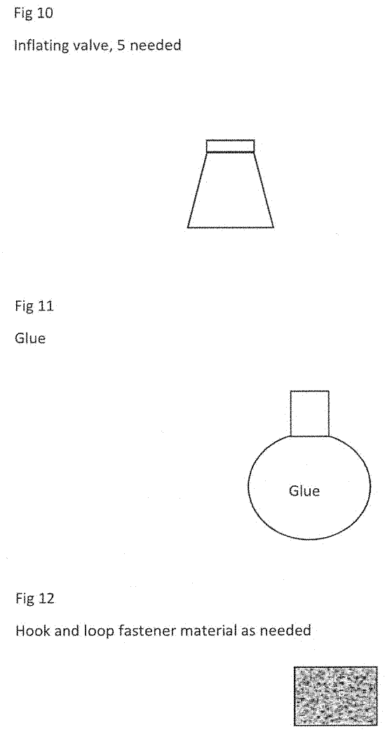

FIG. 10 shows inflating valve

FIG. 11 shows glue

FIG. 12 hook and loop fastener material as needed

1. Hail Stopper III is rectangular shaped made with plastic top and rubber bottom to be inflated or deflated, can be made said rubber top and said rubber bottom where in can be made said plastic top and said plastic bottom where in made in different sized to fit all said vehicles, said rectangular shaped wherein said plastic top is glued to said rubber bottom in a special way a pattern of said glue created cavities within said Hail Stopper III where in the said cavities are used to inflate to be use or said deflated to be stored away, this system gives said Hail Stopper III, the ability to protect your said vehicle from said hail, said Hail Stopper III, where in can said inflate two, four or six inches depending on the hail size in the area, two types are said made twelve inch said cavities, and eighteen inch cavities, where in hook and loop fastener material, rubber rope, to help keep said Hail Stopper III attached to said vehicle, wherein said inflating valve and said deflating plug are used also an electrical twelve volt air pump system is required,
